(19) United States
(12) Patent Application Publication
(10) Pub. No.: US 2026/0187244 A1
(43) Pub. Date: Jul. 2, 2026

(54) MALWARE DETECTION APPARATUS, METHOD AND ELECTRONIC APPARATUS USING THE SAME

(71) Applicant: NUVOTON TECHNOLOGY CORPORATION, HSINCHU CITY (TW)

(72) Inventor: Zong-min Lin, Zhubei City (TW)

(21) Appl. No.: 19/433,503

(22) Filed: Dec. 26, 2025

(30) Foreign Application Priority Data
Dec. 30, 2024 (TW) 113151462

(51) Int. Cl. G06F 21/56

(52) U.S. Cl. CPC G06F 21/563

(57) ABSTRACT

A malware detection apparatus includes a processor and an accelerator processor. The accelerator processor is electrically connected to the processor. The processor operates in a first mode or a second mode, a first authority of the first mode is higher than a second authority of the second mode. The accelerator processor is triggered by the processor under the first mode to read a code block in an untrusted region, use an interpretation model to determine whether a software program corresponding to the code block is malware based on the code block, and generate an interpretation result to the processor.

### CROSS-REFERENCE TO RELATED APPLICATION

This application claims the benefit of Taiwan Patent Application No. 113151462, filed on Dec. 30, 2024, in the Taiwan Intellectual Property Office, the disclosure of which is incorporated herein in its entirety by reference.

### BACKGROUND OF THE INVENTION

### 1. Field of the Invention

The present invention relates to malware detection technology, and particularly to a malware detection apparatus, which realizes machine learning algorithms by setting up an additional accelerator processor and enabling the accelerator processor to read a code block in an untrusted region under a specific mode to further determine whether the software program corresponding to the code block in the untrusted region is malware, and a method thereof, and an electronic apparatus using the same.

### 2. Description of the Related Art

In the field of information security, a common method for identifying malware, such as trojans or worms, is through static analysis, and there are also literatures pointing out that deep learning technology can be configured to train a neural network model to analyze programs, and the neural network model can include a convolutional neural network (CNN), a recurrent neural network (RNN) or a fully-connected layer.

In an Internet of Things (IoT) system, terminal devices have network connections and are likely to download untrusted application programs through the network connection and execute the untrusted application programs to achieve a specific application. These untrusted application programs may contain malware, and once these application programs are executed, they may cause damage to the system. Generally, the codes of the software programs to be executed by the processor are stored in a Random Access Memory (RAM) or a Read-Only Memory (ROM), and this region storing the code to be executed by the processor is also called a program region. This region can be defined; for example, a Memory Protection Unit (MPU) or a Memory Management Unit (MMU) of an ARM architecture processor can define an execute never region to separate the region where the processor is allowed to execute programs from the region where the processor is not allowed to execute programs. When a malicious program is stored the region where programs are allowed to be executed, the malicious programs may be activated and run at a specific moment.

Simply, in prior art, although the deep learning technology can be used to statically analyze whether the software program is malware, the processor still reads the code block where the software program is stored, thus failing to effectively avoid the problem of executing the malware existing in the program region. Moreover, a general terminal device usually operates at a low frequency, and a processor of the general terminal device has a limited computing performance, so it is difficult for the processor to realize neural network computing, or the processing time for malware identification/detection is too long.

### SUMMARY OF THE INVENTION

Therefore, the objective of the present invention is to propose a malware detection apparatus that can avoid a processor from reading malware during an identification process and can realize machine learning computation or reduce the processing time for malware identification, and a method thereof, and an electronic apparatus using the same.

To achieve the objective of the present invention, an embodiment of the present invention provides a malware detection apparatus, the malware detection apparatus includes a processor and an accelerator processor. The accelerator processor is electrically connected to the processor. The processor is configured to operate in a first mode or a second mode, wherein a first authority of the first mode is higher than a second authority of the second mode. When being triggered by the processor operating in the first mode, the accelerator processor reads a code block in an untrusted region, uses an interpretation model to determine whether a software program corresponding to the code block is malware based on the code block, and generates and transmits an interpretation result to the processor.

To achieve the objective of the present invention, an embodiment of the present invention provides an electronic apparatus including a malware detection apparatus, a storage device and a memory device; the storage device and the memory device are electrically connected to the malware detection apparatus.

To achieve the objective of the present invention, an embodiment of the present invention provides a malware detection method executed in a malware detection apparatus including a processor and an accelerator processor. The processor operates in a first mode or a second mode, a first authority of the first mode is higher than a second authority of the second mode, and the malware detection method includes steps of: enabling the processor to trigger the accelerator processor in the first mode; enabling the triggered accelerator processor to read a code block in an untrusted region; enabling the triggered accelerator processor to use an interpretation model to determine whether a software program corresponding to the code block is malware based on the code block and to generate and transmit an interpretation result to the processor.

Compared with the prior art, the malware detection apparatus and the method provided by the present invention can be implemented using a processor with low computing capability, so that an electronic apparatus with low computing performance (e.g., a terminal device on the Internet of Things) can also perform malware identification using machine learning algorithms. Through the technical solution having modes with different authorities, each hardware circuit can only be operated and accessed under the allowed mode, thus effectively avoiding the processor from reading malware and destroying the malware detection program.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a malware detection apparatus of an electronic apparatus according to an embodiment of the present invention.

FIG. 2 is a flowchart of a malware detection method according to an embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure can be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete and fully conveys the inventive concept to those skilled in the art. Regarding the drawings, the relative proportions, and ratios of elements in the drawings can be exaggerated or diminished in size for the sake of clarity and convenience. Such arbitrary proportions are only illustrative and not limiting in any way. The same reference numbers are used in the drawings and descriptions to refer to the same or like parts. As used herein, the singular forms “a”, “an” and “the” are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

To enable an electronic apparatus with low computing performance (e.g., a terminal device on the Internet of Things) to perform malware identification using machine learning algorithms and effectively avoid the processor from reading malware and destroying the malware detection program, in the present invention, an additional accelerator processor is set to realize a machine learning algorithm and each of hardware circuits is designed to be operated and accessed by the processor under the allowed mode only, so that a code block of the untrusted region can be read by the accelerator processor triggered by the processor under the specific mode to further determine whether a software program stored in the code block of the untrusted region is malware, thereby preventing the malware from being executed by the processor under the specific mode and from tampering with the malware detection program, the interpretation result, and the model data. Embodiments of the present invention will be described in detail below with reference to the drawings, but it should be noted that the following implementation details are not intended to limit the scope of the patent application claimed by the present invention, but, are only for the convenience of understanding by those having ordinary skill in the art.

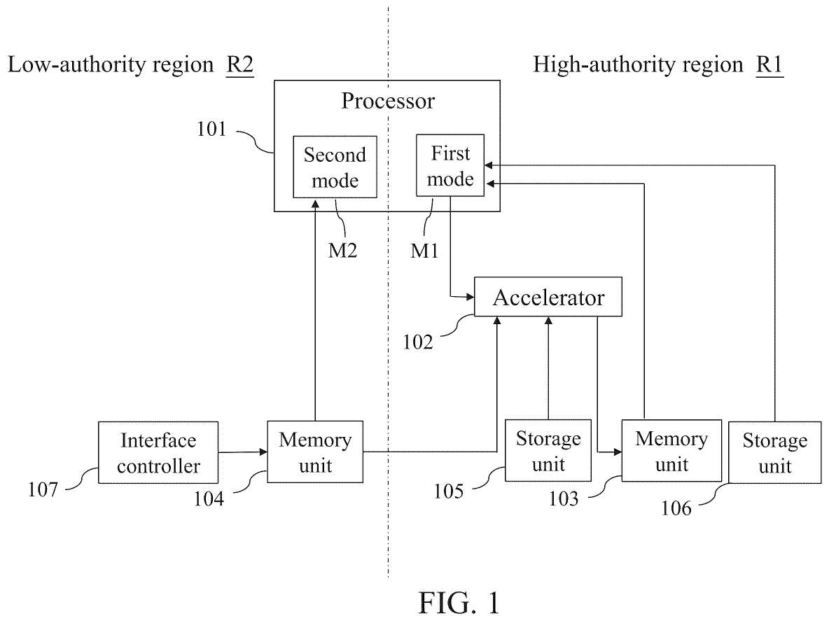

Please refer to FIG. 1. FIG. 1 is a block diagram of a malware detection apparatus of an electronic apparatus according to an embodiment of the present invention. The electronic apparatus includes a malware detection apparatus, a memory device, and a storage device. The malware detection apparatus includes a processor 101 and an accelerator processor 102 and can also include at least one of memory units 103 and 104, storage units 105 and 106, and an interface controller 107.

Furthermore, the memory units 103 and 104 are a part of the memory device, the storage units 105 and 106 are a part of the storage device, and the memory device and the storage device are electrically connected to the malware detection apparatus, but the present invention is not limited thereto. For example, in an embodiment, the memory units 103 and 104, and the storage units 105 and 106 are independent hardware of the malware detection apparatus and are not implemented by the memory devices and the storage devices.

In an embodiment, the electronic apparatus can include a computing processor, which serves as the processor 101 of the malware detection apparatus. In an embodiment, the electronic apparatus can include a plurality of computing processors, and one of the computing processors of the electronic apparatus serves as the processor 101 of the malware detection apparatus. In an embodiment, the electronic apparatus can include a plurality of computing processors, which cooperatively serve as the processor 101 of the malware detection apparatus.

The accelerator processor 102 is electrically connected to the processor 101, the memory unit 103 is electrically connected to the processor 101 and the accelerator processor 102, the memory unit 104 is electrically connected to the processor 101 and the accelerator processor 102, the storage unit 105 is electrically connected to the accelerator processor 102, the storage unit 106 is electrically connected to the processor 101, and the interface controller 107 is electrically connected to the memory unit 104.

In the present invention, the processor 101 operates in a first mode M1 or a second mode M2, a first authority of the first mode M1 is higher than a second authority of the second mode M2. For example, the first mode M1 is a high authority mode and the second mode M2 is a low authority mode. When the processor 101 is implemented by a Cortex M series processor (e.g., Cortex M55) with ARM architecture, the first mode M1 is a secure mode and the second mode M2 is a non-secure mode.

With the scheme having modes with different authorities, the hardware configuration area can be physically or logically divided into a high-authority region R1 and a low-authority region R2, the hardware circuits configured in the high-authority region R1 can be configured or accessed by the processor in the first mode M1, but cannot be configured or accessed by the processor under the second mode M2; and the hardware circuits configured in the low-authority region R2 can be configured or accessed by the processor in the first mode M1 and the second mode M2.

Furthermore, a part of the processor 101, which is configured to operate in the first mode M1, is configured in the high-authority region R1; another part of the processor 101, which is configured to operate in the second mode M2, is configured in the low-authority region R2; the memory unit 103, the storage units 105 and 106, and the accelerator processor 102 are configured/disposed in the high-authority region R1; the second memory unit 104 and the interface controller 107 are configured/disposed in the low-authority region R2.

When operating under the first mode M1, the processor 101 is capable of executing the malware detection program to set the read address, trigger the accelerator processor 102 and send the read address to the accelerator processor 102. The memory unit 104 is defined as the untrusted region and the program region and configured to store one or more code block of the software program. The triggered accelerator processor 102 reads the code block from the untrusted region based on the read address, uses an interpretation model to determine whether a software program corresponding to the code block is malware based on the code block, and generates an interpretation result to the processor 101.

When operating under the second mode M2, the processor 101 is capable of accessing the code block in the untrusted region to execute the software program corresponding to the code block. Furthermore, in one implementation, under the first mode M1 the processor 101 is designed to be allowed to access the code block in the memory unit 104, which is an untrusted region, that is, under the first mode M1 the processor 101 is able to execute the software program corresponding to the code block; in another implementation, under the first mode M1 the processor 101 is designed to be prohibited from accessing the code block in the memory unit 104, which is an untrusted region; that is, under the first mode M1 the processor 101 is unable to execute the software program corresponding to the code block.

The accelerator processor 102 primarily serves as a hardware circuit that accelerates machine learning algorithms, thereby enabling an electronic apparatus (e.g., a terminal IoT device) with low computing power to perform malware identification/detection using machine learning algorithms. The accelerator processor 102 can be a neural network computing unit and can be implemented by an ARM Ethos U series neural network computing unit such as Ethos U55 or Ethos U85.

The interpretation model configured above can include at least one of a convolutional neural network, a feedforward neural network, a support vector machine (SVM), a long short-term memory network (1STM), a recurrent neural network, a gated recurrent unit (GRU), and a K Nearest Neighbor (KNN) classification model. The interpretation model can have a fully-connected layer or a partially-connected layer at the backend of the convolutional neural network. When the interpretation model has the convolutional neural network, one-dimensional sequence data in the code block can be converted into two-dimensional data, which is similar to image data, through a conversion manner such as Gramian Angular Field (GAF) conversion, but the present invention is not limited thereto.

In an embodiment, the accelerator processor 102 can include a plurality of multiply accumulate (MAC) computing units, a plurality of kernel function computing units, a plurality of pooling computing units, a plurality of rectified linear units (RLU), and a plurality of sigmoid activation function computing units.

The accelerator processor 102 can include an active interface and a passive interface. After the accelerator processor 102 is triggered, the active interface is configured to request model data of the interpretation model from the storage unit 105. After an interpretation operation is completed, the interpretation result is temporarily stored in the memory unit 103. The passive interface is configured to receive the read address and the trigger signal generated by the processor 101 for triggering the accelerator processor 102.

The memory unit 103 is configured for temporarily storing the interpretation result generated by the accelerator processor 102 and allowing the processor 101 to read the interpretation result under the first mode M1. The memory unit 103 is configured in the high authority region R1, so that under the second mode M2, the processor 101 is prohibited from accessing the interpretation result from the memory unit 103. In other words, the interpretation result temporarily stored in the memory unit 103 is isolated and protected from being tampered by the malware.

As described above, the memory unit 104 is configured as the untrusted region and temporarily stores the code block of the software program. The code block temporarily stored in the memory unit 104 in the high-authority region R1 can be read by the accelerator processor 102 for malware identification and detection. Under the second mode M2, the processor 101 is allowed to read the code block from the memory unit 104 to execute the corresponding software program. However, when the software program has been determined as malware by the processor 101 under the first mode M1, the processor 101 prohibits the software program from being executed under the first mode MI and the second mode M2, or the processor 101 deletes the code block of the software program in the memory unit 104 to prevent the software program from being executed.

The interface controller 107 in the low-authority region R2 is configured to update the code block of the software program stored in the memory unit 104. The interface controller 107 can be implemented by an Ethernet interface controller. Generally, in IoT applications, the terminal device downloads the software program into the memory unit 104 through the interface controller 107. Therefore, the software program in the memory unit 104 can usually only be executed by the processor 101 under the second mode M2, and in the present invention the accelerator processor 102 can be used to identify whether the software program in the memory unit 104 is malware.

The storage unit 105 is configured to store the model data of the interpretation model and allow the accelerator processor 102 to read the model data. Because the model data is data generated by training the interpretation model, after the accelerator processor 102 reads the model data, the interpretation model used by the accelerator processor 102 becomes the trained interpretation model capable of determining whether the software program is malware with a certain accuracy. The storage unit 105 is disposed in the high-authority region R1, so the processor 101 is prohibited from accessing the model data from the storage unit 105 under the second mode M2, thereby preventing the model data from being tampered with by the malware.

The storage unit 106 is defined as the trusted region and the program region and configured to store the malware detection program. The processor reads the malware detection program from the storage unit 106 under the first mode M1, executes the malware detection program to trigger the accelerator processor 102, sets the read address corresponding to the code block stored in the memory unit 104, and causes the read address to be transmitted to the accelerator processor 102. The storage unit 106 is configured in the high-authority region R1, so the processor 101 is prohibited from accessing the malware detection program from the storage unit 106 in the second mode M2, thereby preventing the malware detection program from being tampered with by the malware.

It is noted that the software program can have a plurality of code blocks, and the above malware detection and identification can be performed sequentially for all code blocks under the first mode M1. In other words, the accelerator processor 102 reads each of the code blocks and uses the interpretation model for interpretation, and generates an interpretation result for each code block. The malware detection process ends only when all code blocks are read and interpreted.

For example, the software program can include a first code block, and a second code block. The first code block and the second code block are stored in the untrusted region. The accelerator processor 102 is triggered by the processor 101, which operates under the first mode M1, to read the first code block in an untrusted region, uses the interpretation model to determine whether a software program corresponding to the first code block is malware based on the first code block, and generates an interpretation result to the processor 101. Next, the accelerator processor 102 is triggered again by the processor 101 to read the second code block in the untrusted region, use the interpretation model to determine whether a software program corresponding to the second code block is malware based on the second code block, and generate an interpretation result to the processor 101.

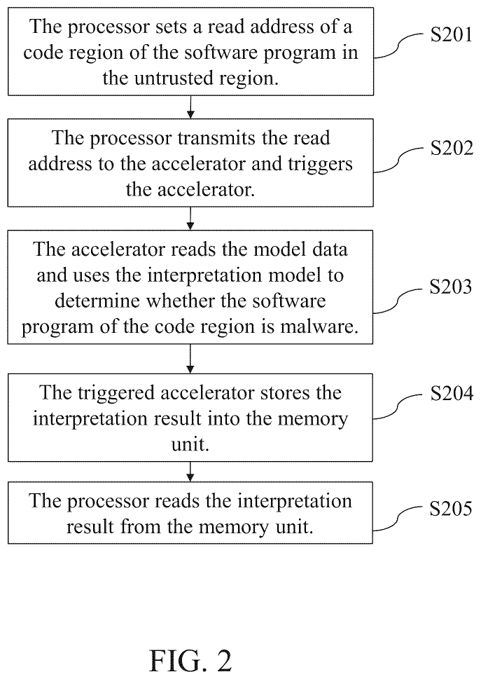

Please refer to FIG. 1 and FIG. 2. FIG. 2 is a flowchart of malware detection method according to an embodiment of the present invention. The malware detection apparatus is configured to execute the malware detection method, and the malware detection method at least includes steps S201 to S205. In addition, in other embodiments, the malware detection method can include steps of the functions executed by the malware detection apparatus.

In this embodiment, in step S201, the processor 101 sets a read address of a code block of the software program in the untrusted region under the first mode M1. In step S202, the processor 101 transmits the read address to the accelerator processor 102 under the first mode M1 and triggers the accelerator processor 102 to read the code block. In step S203, the triggered accelerator processor 102 reads the model data, and uses the interpretation model to determine whether the software program of the code block is malware. In step S204, the triggered accelerator processor 102 stores the interpretation result into the memory unit 103. In step S205, the processor 101 reads the interpretation result from the memory unit 103 under the first mode M1.

In summary, the malware detection apparatus, the method and the electronic apparatus using the same provided by the present invention have the following features. First, the prior art can implement malware identification using machine learning algorithms on computing devices with high computing power but fail to implement malware identification on an electronic apparatus with low computing power; in the present invention, an additional accelerator processor is set up to allow an electronic apparatus with low computing power (e.g., a terminal IoT device) to identify malware using a machine learning algorithm. Secondly, with the scheme having modes with different authorities, the hardware circuits can have access restrictions in the modes with different authorities, thereby achieving the purpose of storing data with hardware isolation; this isolation technology separates the access authorities of malware and the malicious detection program, thereby preventing the malware from being read by the processor to destroy the malware detection program, the interpretation result, and the model data. Thirdly, in the present invention, the untrusted region can be defined, the untrusted region is a program region and configured for storing one or more code block of the software program, the accelerator processor is triggered by the processor to receive the read address set by the processor and read the code block from the untrusted region for interpretation, to avoid the accelerator processor from interpreting unrelated data region, thereby reducing the amount of computation and the overall power consumption. Fourthly, a trusted region can be defined in the present invention, and the trusted region is a program region, so the electronic apparatus only needs one processor to provide both secure and non-secure execution environments, thus further reducing the system hardware cost.

The present invention disclosed herein has been described by means of specific embodiments. However, numerous modifications, variations and enhancements can be made thereto by those skilled in the art without departing from the spirit and scope of the disclosure set forth in the claims.

1. A malware detection apparatus, comprising:
a processor, configured to operate in a first mode or a second mode, wherein a first authority of the first mode is higher than a second authority of the second mode;
an accelerator processor, electrically connected to the processor, wherein when being triggered by the processor operating in the first mode, the accelerator processor reads a code block in an untrusted region, uses an interpretation model to determine whether a software program corresponding to the code block is malware based on the code block, and generates and transmits an interpretation result to the processor.

2. The malware detection apparatus according to claim 1, further comprising:
a first memory unit, electrically connected to the processor and the accelerator processor, and configured to temporarily store the interpretation result generated by the accelerator processor, and allow the processor to read the interpretation result in the first mode, wherein the processor is prohibited from accessing the interpretation result from the first memory unit in the second mode.

3. The malware detection apparatus according to claim 2, further comprising:
a second memory unit, electrically connected to the processor and the accelerator processor, and configured to serve as the untrusted region and temporarily store the code block of the software program, wherein the processor is allowed to read the code block from the second memory unit in the second mode.

4. The malware detection apparatus according to claim 3, further comprising:
a first storage unit, electrically connected to the accelerator processor, and configured to store model data of the interpretation model and allow the accelerator processor, which is triggered by the processor operating in the first mode, to read the model data, wherein the processor is prohibited from accessing the model data from the first storage unit in the second mode.

5. The malware detection apparatus according to claim 4, further comprising:
a second storage unit, electrically connected to the processor, configured to serve as the trusted region and store malware detection program, wherein the processor reads the malware detection program from the second storage unit in the first mode, executes the malware detection program, triggers the accelerator processor, and transmits a read address corresponding to the code block stored in the second memory unit to the accelerator processor, and the processor is prohibited from accessing the malware detection program from the second storage unit in the second mode.

6. The malware detection apparatus according to claim 1, wherein the interpretation model comprises at least one of a convolutional neural network, a feedforward neural network, a support vector machine (SVM), a long short-term memory network, a recurrent neural network, a gated recurrent unit, and a K-Nearest Neighbor (KNN) classification model.

7. The malware detection apparatus according to claim 5, wherein a part of the processor is disposed in a high-authority region, another part of the processor is configured in a low-authority region, wherein the first memory unit, the first storage unit, the second storage unit and the accelerator processor are disposed in the high-authority region, and the second memory unit is disposed in the low-authority region.

8. An electronic apparatus, comprising:
the malware detection apparatus according to claim 1;
a storage device, electrically connected to the malware detection apparatus; and
a memory device, electrically connected to the malware detection apparatus.

9. A malware detection method, executed in malware detection apparatus comprising a processor and an accelerator processor, wherein the processor operates in a first mode or a second mode, a first authority of the first mode is higher than a second authority of the second mode, and the malware detection method comprises:
enabling the processor to trigger the accelerator processor in the first mode;
enabling the triggered accelerator processor to read a code block in an untrusted region;
enabling the triggered accelerator processor to use an interpretation model to determine whether a software program corresponding to the code block is malware based on the code block and to generate and transmit an interpretation result to the processor.

10. The malware detection method according to claim 9, wherein a first memory unit of the malware detection apparatus temporarily stores the interpretation result generated by the accelerator processor and allows the processor to read the interpretation result in the first mode, and the processor is prohibited from accessing the interpretation result from the first memory unit in the second mode, wherein a second memory unit of the malware detection apparatus serves as the untrusted region, and temporarily stores the code block of the software program, the processor is allowed to read the code block from the second memory unit in the second mode, wherein the processor is allowed to access the code block from the second memory unit under the first mode, or the processor is prohibited from accessing the code block from the second memory unit in the first mode.
